(19) United States
(12) Patent Application Publication
(10) Pub. No.: US 2025/0042096 A1
(43) Pub. Date: Feb. 6, 2025

(54) SEALING DEVICE, SEALING STATION AND METHOD FOR OPERATING A SEALING DEVICE

(71) Applicant: Ampack GmbH, Königsbrunn (DE)

(72) Inventors: Jürgen Haak, Sonnenbühl (DE); Markus Zimmermann, Landsberg am Lech (DE); Alexander Gaab, Aurach (DE); Ilona Klein, Neufahrn bei Freising (DE); Alois Sturm, Friedberg (DE)

(21) Appl. No.: 18/693,010

(22) PCT Filed: Sep. 23, 2022
(86) PCT No.: PCT/EP2022/076471

§ 371 Date: Mar. 18, 2024

(30) Foreign Application Priority Data
Sep. 24, 2021 (DE) 10 2021 124 794.2

(51) Int. Cl. B29C 65/18; B29C 65/00; B29C 65/82

(52) U.S. Cl. CPC B29C 65/18; B29C 65/8261; B29C 66/91216

(57) ABSTRACT

A sealing device, in particular a sealing head, for sealing a container has at least one sealing unit for a force and/or energy transmission, generating a sealing, to the container, and has at least one test unit (16a), integrated at least partly in the sealing unit, for monitoring a sealing quality of the container sealed by the sealing unit. The test unit includes at least one temperature sensor for detecting a sealing temperature. The temperature sensor is arranged in a sensor material recess of a base body of a heating unit of the sealing unit, and/or the temperature sensor is arranged in a sensor material recess of a sealing tool of the sealing unit. The sensor material recess of the sealing tool is arranged in a proximity of the heating unit.

### CROSS REFERENCE TO RELATED APPLICATIONS

This patent application claims the benefit of and incorporates herein by reference the German patent application DE 10 2021 124 794.2, filed on Sep. 24, 2021, and the international patent application PCT/EP2022/076471, filed on Sep. 23, 2022.

### BACKGROUND

A sealing device, in particular a sealing head, for sealing a container, having at least one sealing unit for a force and/or energy transmission to the container in order to generate sealing, has already been proposed in EP 3 515 693 B1.

Sealing devices for sealing a container are further already known from U.S. Pat. No. 7,490,448 B1, US 2009/0044497 A1, CN 215 323 675 U, US 2008/0072550 A1, DE 24 55 064 A1 and US 2002/0121073 A1, wherein the sealing devices already known comprise at least one sealing unit for a force and/or energy transmission to the container in order to generate sealing, and at least one test unit, integrated at least partly in the sealing unit, for monitoring a sealing quality of the container sealed by the sealing unit.

### SUMMARY

The invention proceeds from a sealing device, in particular a sealing head, for sealing a container, having at least one sealing unit for a force and/or energy transmission, generating a sealing, to the container, and having at least one test unit, integrated at least partly in the sealing unit, for monitoring a sealing quality of the container sealed by the sealing unit, wherein the test unit comprises at least one temperature sensor for detecting a sealing temperature.

It is proposed that the temperature sensor is arranged in a sensor material recess of a, in particular ceramics, base body of a, in particular ceramics, heating unit of the sealing unit, and/or that the temperature sensor is arranged in a sensor material recess of a sealing tool of the sealing unit, wherein the sensor material recess of the sealing tool is arranged in a proximity of the, in particular ceramics, heating unit. By means of the implementation according to the invention of the sealing device, sensor data for determining the sealing quality can advantageously be collected during sealing and/or immediately thereafter. Separate testing of the sealing quality, in particular a separate container checking station, following sealing can be omitted. In particular, an overall length and a throughput time of a filling and/or production system, which uses the sealing device, for filling the containers with the material to be packaged can thus advantageously be kept low. By means of the implementation according to the invention, the sealing temperature can advantageously be detected individually for each of the containers to be sealed. In particular, a change in the sealing temperature during sealing can advantageously be monitored. In particular, the sealing temperature can be evaluated in order to determine the sealing quality. For example, on the basis of different temperature changes, it is advantageously possible to distinguish between a bent container lid, a double-layered container lid, a container lid displaced relative to the receiving unit, a contaminant, such as, for example, a fluid, a food residue or other contaminants, between the container and the container lid, or the like.

Preferably, in at least one embodiment of the sealing device according to the invention the temperature sensor is arranged in a sensor material recess of the sealing tool, said recess being arranged in a proximity of the, in particular ceramics, base body of the, in particular ceramics, heating unit. Preferably, in the case where the sensor material recess is arranged in a proximity of the, in particular ceramics, base body of the, in particular ceramics, heating unit, the sensor material recess is arranged outside the, in particular ceramics, base body of the, in particular ceramics, heating unit, preferably directly in the sealing tool. The “vicinity” is to be understood in particular as being a region of an element which is at a maximum distance, in particular relative to a further element, in particular to an outer surface of the further element that faces the element, in particular of less than 25 mm, preferably of less than 10 mm and particularly preferably of less than 8 mm. Preferably, the temperature sensor is at a maximum distance relative to the, in particular ceramics, heating unit, in particular relative to the base body, in particular of less than 25 mm, preferably of less than 10 mm and particularly preferably of less than 8 mm. Preferably, the temperature sensor is arranged in the sensor material recess of the sealing tool in such a manner that the temperature sensor, in particular a temperature detection region of the temperature sensor, such as, for example, a temperature sensor tip or the like, is arranged spaced apart from a sealing surface, in particular a sealing outer surface, of the sealing tool or a contact plane of the sealing unit by a distance, in particular a maximum distance, of in particular less than 10 mm, preferably of less than 5 mm and particularly preferably of less than 2 mm. Preferably, the temperature sensor, in a state arranged in the sensor material recess of the sealing tool, has a distance, in particular a maximum distance, with a value of between 0.1 mm and 5 mm in a direction running at least substantially perpendicular to the sealing surface of the sealing tool.

It is conceivable that in at least one embodiment of the sealing device according to the invention the temperature sensor is arranged in the sensor material recess of the sealing tool and in the sensor material recess of the base body of the heating unit. The temperature sensor can be arranged in part in the base body of the heating unit and in part in the sealing tool. The temperature sensor can extend through the entire base body into the sealing tool. It is also conceivable that the temperature sensor is arranged wholly outside the base body. It is additionally conceivable that the test unit has two separate temperature sensors, wherein one of the temperature sensors is arranged in or on the sealing tool and the other of the temperature sensors is arranged in or on the base body, in particular in order to allow an advantageous target/actual comparison of a temperature, in particular a comparison of a desired target temperature at the base body of the heating unit with an actual temperature actually prevailing at the sealing tool. Advantageously, by providing two separate temperature sensors, in which one of the temperature sensors is arranged on the sealing tool and another of the temperature sensors is arranged on the base body of the heating unit, a redundant temperature detection can preferably be made possible.

The temperature sensor is preferably in the form of a contact sensor, particularly preferably in the form of a resistance thermometer, alternatively in the form of an expansion thermometer, or thermocouple. Preferably, the temperature sensor is arranged on the energy and/or force transmission element and/or on the sealing tool or is embedded in the energy and/or force transmission element and/or in the sealing tool. Alternatively, the temperature sensor is arranged on or in the sealing holder. Alternatively, the temperature sensor is configured for the contactless measurement of the sealing temperature and is in the form of, for example, a pyrometer or thermal imaging camera. Preferably, the temperature sensor is configured to detect as the sealing temperature a temperature of the energy and/or force transmission element, of the sealing tool and/or of the container. Preferably, the temperature sensor is configured to detect a temperature drop of the energy and/or force transmission element and/or of the sealing tool on contact with the container. Alternatively, the temperature sensor is configured to detect a temperature increase of the container on contact with the energy and/or force transmission element and/or with the sealing tool.

The heating unit can have any form which appears expedient to a person skilled in the art, such as, for example, the form of a heating cartridge unit, a heating wire unit, a ceramics heating unit or the like. The base body of the heating unit can be formed of any material which appears expedient to a person skilled in the art, such as, for example, of metal, of a composite material, of ceramics or the like. Preferably, the heating unit is in the form of a ceramics heating unit. Preferably, the base body of the heating unit is in the form of a ceramics base body. It is, however, also conceivable that the base body of the heating unit is in the form of a metallic base body, such as, for example, a base body of copper, of stainless steel or the like.

The container comprises in particular a receiving unit, which is configured to receive a material to be packaged, and in particular a container lid. The material to be packaged can be, for example, a liquid, a pasty composition, a bulk material and/or piece goods. The material to be packaged is, for example, a foodstuff, a pharmaceutical product, a commodity or the like. The receiving unit can in particular be in the form of a cup, a bottle, a tube, a dish, a box or the like. The receiving unit is preferably sealed with the container lid. Preferably, the container lid is configured to close the receiving unit in a water-tight and/or air-tight manner as a result of the sealing. In particular in dependence on the material to be packaged, the receiving unit and/or the container lid can be produced from metal, glass, ceramics, wood, paper, plastics material and/or a composite material. The receiving unit and the container lid can be produced from the same material or from different materials. Preferably, the container lid is in the form of a film or in the form of a sheet, in particular in the form of a sealing plate.

The sealing unit is configured to join the container lid, which is resting, in particular loosely, on the receiving unit, to the receiving unit by material bonding by force and/or energy transmission and thus to seal the container. The sealing unit comprises in particular at least one force and/or energy transmission element for a force and/or energy transmission to the container lid and/or to the receiving unit. For example, the sealing unit comprises as the force and/or energy transmission element at least one electrical heating element, an ultrasonic generator, a pressing tool or the like. Preferably, the sealing unit comprises at least one sealing holder, on which the force and/or energy transmission element is arranged. The sealing unit preferably comprises a sealing tool for direct contact with the container, preferably with the container lid. The sealing tool is arranged in particular on the sealing holder and/or on the force and/or energy transmission element. The sealing tool can be in the form of a single component or in one-part form with the force and/or energy transmission element. “One-part” is to be understood in particular as meaning formed in one piece. Preferably, this one piece is produced from a single blank, a composition and/or a casting, particularly preferably in an injection molding process, in particular a single- and/or multi-component injection molding process. Preferably, the sealing unit comprises at least one drive element for moving the sealing holder in a sealing direction. The drive element is configured in particular to bring the sealing tool into physical contact with the container before sealing and in particular to remove it from the container after sealing. Preferably, the drive element is in the form of a linear drive, a step motor or a servo drive.

The test unit comprises in particular at least one sensor element which is arranged in or on the sealing unit and is configured to detect at least one test parameter. The test parameter describes or characterizes in particular a process sequence of sealing and/or a result of sealing. The test unit is configured in particular to detect as the test parameter at least one operating parameter of the sealing unit, a process parameter of sealing with the sealing unit and/or a container parameter of the container, in particular during sealing. For example, the sensor element is in the form of a temperature sensor, a pressure sensor, an electric current and/or voltage sensor, a force meter, a vibration sensor or the like. In particular in dependence on the test parameter to be detected, the sensor element can be arranged on or in the sealing holder, on or in the energy and/or force transmission element, on or in the sealing tool, on or in the drive element or on or in another component of the sealing unit. Preferably, the test unit comprises multiple sensor elements, which are arranged in or on the sealing unit, in particular for the redundant detection of the test parameter, for a spatially resolved detection of the test parameter and/or for the detection of multiple different test parameters. Optionally, the test unit comprises at least one further sensor element which is arranged spaced apart from the sealing unit. The further sensor element is configured in particular to detect the test parameter or a further test parameter in a contactless manner and is in the form of, for example, a camera, an infrared sensor, an ultraviolet sensor or the like.

The test unit preferably comprises a computing unit for evaluating the test parameter detected by means of the at least one sensor element and/or the further sensor element. The computing unit preferably comprises an information input, information processing and an information output. Advantageously, the computing unit has at least one processor, a memory, an input and output means, further electrical components, an operating program, regulation routines, controlling routines and/or calculation routines. Preferably, the components of the computing unit are arranged on a common circuit board and/or advantageously arranged in a common housing. The computing unit can be arranged in or on the sealing unit or spaced apart from the sealing unit. The computing unit spaced apart from the sealing unit can, for example, be in the form of an individual unit, can be part of a system controller of a sealing station comprising the sealing device, or can be implemented by an external computing system, in particular a server or a cloud. The computing unit is configured in particular to determine sensor data in respect of the sealing quality of the container sealed by the sealing unit. The computing unit is configured in particular to output a fault signal if a value of the sealing quality is below a limit value of the sealing quality and/or if a value of the test parameter is outside a range of tolerance of the test parameter, in particular in order to separate out the corresponding container and/or to determine a fault source.

It is further proposed that the test unit comprises at least two, in particular multiple, temperature sensors for the spatially resolved detection of a sealing temperature, in particular the sealing temperature already mentioned. In particular, the sealing unit comprises a contact plane, in particular the contact plane already mentioned above, in which components of the sealing unit which are configured for contact with the container are arranged. A main plane of extent of the sealing holder is preferably arranged at least substantially parallel to the contact plane. The contact plane has in particular an annular sealing zone. The annular sealing zone has in particular an outer contour and an inner contour which lies wholly inside the outer contour and delimits the sealing zone. The outer contour and/or the inner contour of the annular sealing zone can have in particular a circular, rectangular, triangular or any other two-dimensional, closed structure. The outer contour and the inner contour can be arranged concentrically or eccentrically to one another. In particular, the energy and/or force transmission element and/or the sealing tool is arranged in the annular sealing zone. Preferably, the annular sealing zone forms the sealing surface of the sealing tool. Preferably, the annular sealing zone is divided into at least two segments. Preferably, the sealing unit comprises at least one further energy and/or force transmission element. Preferably, at least the majority of the segments, preferably each segment, of the annular sealing zone comprises at least one of the energy and/or force transmission elements of the sealing unit and/or at least one sealing tool element of the sealing tool. The energy and/or force transmission elements can each be realized independently and/or actuatable independently or can be segments of an energy and/or force transmission unit of the sealing unit. The sealing tool elements can each be realized as independent components or can be segments of the sealing tool. Preferably, at least one temperature sensor is associated with at least two segments, preferably at least the majority of the segments, particularly preferably each segment, of the annular sealing zone. In particular, the temperature sensor associated with a segment of the annular sealing zone is configured to detect a temperature of the energy and/or force transmission element arranged in that segment and/or of the sealing tool element arranged in that segment. Optionally, at least two of the temperature sensors are associated with at least one segment of the sealing zone, in particular for the redundant detection of the temperature in that segment. By means of the implementation according to the invention, the sealing quality of a container can advantageously be detected accurately and reliably. In particular, small deformations and/or defects can advantageously be precisely detected. In particular, a possible fault source in the case of defective sealing can advantageously be isolated.

It is further proposed that the test unit comprises at least one applied-pressure sensor for detecting a sealing force and/or a sealing pressure. The sealing force and/or the sealing pressure is in particular the force and/or the pressure with which the drive element presses the energy and/or force transmission element and/or the sealing tool against the container. The applied-pressure sensor can in particular be in the form of a tensile force sensor, a compressive force sensor, a compressive force transducer, a spring force meter, a pressure sensor, in particular a hydraulic system or a pneumatic system of the sealing unit, or the like. By means of the implementation according to the invention, the sealing force and/or the sealing pressure can advantageously be detected individually for each container to be sealed. In particular, a change in the sealing force and/or in the sealing pressure during sealing can advantageously be monitored. In particular, the sealing force and/or the sealing pressure can be evaluated in order to determine the sealing quality. For example, on the basis of different pressure and/or force changes, it is advantageously possible to distinguish between a bent container lid, a double-layered container lid, a container lid displaced relative to the receiving unit, or the like.

It is further proposed that the test unit comprises a pneumatic cylinder in or on which the applied-pressure sensor is arranged. The pneumatic cylinder is arranged in particular between the sealing holder and the drive element. The pneumatic cylinder comprises in particular at least one cylinder housing, a piston arranged in the cylinder housing, and at least one gas line which opens into the cylinder housing. For the transmission of force and/or pressure from the drive element to the sealing holder, the piston is connected in terms of drive to the drive element, for example, and the cylinder housing is connected in terms of drive to the sealing holder. Alternatively, the cylinder housing is connected in terms of drive to the drive element and the piston is connected in terms of drive to the sealing holder. Examples of a connection of two objects in terms of drive include a direct arrangement of the objects on one another or an indirect connection by means of a rigid transmission element, by means of a gear, by means of a hydraulic system and/or by means of a pneumatic system of the sealing unit. The test unit preferably comprises at least one check valve in the gas line of the pneumatic cylinder in order to keep the pneumatic cylinder in a pre-stressed state during operation of the sealing device, that is to say in order to maintain a pre-set pressure standard within the cylinder housing while the pneumatic cylinder is in an unloaded state. The pressure standard is in particular different from an ambient pressure, in particular greater or less, preferably greater or less by at least a factor of 1.25, than the ambient pressure. The pneumatic cylinder is in an unloaded state in particular when the sealing device is spaced apart from the container. The pneumatic cylinder is in a loaded state in particular when the sealing device is in physical contact with the container. In particular, the pressure within the cylinder housing rises or falls relative to the pressure standard when the pneumatic cylinder changes into the loaded state. Preferably, the applied-pressure sensor is arranged in the gas line of the pneumatic cylinder, in particular between the shut-off valve and the cylinder housing. Alternatively, the applied-pressure sensor is arranged in a protrusion of the cylinder housing or of the piston or in a region of the cylinder housing separate from a piston holder of the cylinder housing. The applied-pressure sensor can be integrated directly in the pneumatic cylinder or can be in the form of an independent component which is fixed to the pneumatic cylinder, in particular to or in the gas line. The applied-pressure sensor is configured in particular to detect a pressure inside the cylinder housing of the pneumatic cylinder. In particular, the applied-pressure sensor is configured to record a deviation of a gas pressure inside the cylinder housing from the pressure standard. Alternatively, the computing unit is configured to determine the deviation of the gas pressure inside the cylinder housing from the pressure standard in dependence on a measurement of the applied-pressure sensor. By means of the implementation according to the invention, the sealing force and/or the sealing pressure can be detected advantageously in a simple manner and/or advantageously inexpensively.

It is further proposed, in particular in at least one embodiment of the sealing device according to the invention, that the test unit comprises at least two, in particular multiple, temperature sensors and a computing unit, in particular the computing unit already mentioned above, for evaluating the test parameter detected by means of the temperature sensors, wherein the computing unit is configured to determine the sealing quality in dependence on a comparison of two values of the test parameter which are detected in at least two different measurement points associated with the same container. It is conceivable that the sealing device, in order to achieve the object of permitting a structurally simple and reliable determination of a sealing quality, is realized in an alternative embodiment independently of the arrangement of the temperature sensor in a sensor material recess. Preferably, the sealing device in the alternative embodiment, in particular in the embodiment realized independently of the arrangement of the temperature sensor in a sensor material recess, comprises at least one sealing unit for a force and/or energy transmission, generating a sealing, to a container, and at least one test unit, integrated at least partly in the sealing unit, for monitoring a sealing quality of the container sealed by the sealing unit, wherein the test unit comprises at least one temperature sensor for detecting a sealing temperature, wherein the test unit comprises at least two, in particular multiple, temperature sensors and a computing unit, in particular the computing unit already mentioned above, for evaluating the test parameter detected by means of the temperature sensors, wherein the computing unit is configured to determine the sealing quality in dependence on a comparison of two values of the test parameter which are detected in at least two different measurement points associated with the same container. Preferably, the two temperature sensors are arranged at different positions on the heating unit and/or the sealing tool. The temperature sensors are preferably arranged evenly on the heating unit and/or on the sealing tool along a longitudinal or main axis of extent of the base body of the heating unit. Preferably, the temperature sensors are arranged on the heating unit and/or the sealing tool in accordance with an n-fold symmetry. In particular, “n” represents the number of temperature sensors. For example, the temperature sensors are arranged on the heating unit and/or on the sealing tool so as to be offset relative to one another by 180° in the case of a maximum number of two temperature sensors, by 120° in the case of a maximum number of three temperature sensors, by 90° in the case of a maximum number of four temperature sensors, etc. It is, however, also conceivable that the temperature sensors, in particular in dependence on the field of application, are arranged in an unevenly distributed manner on the heating unit and/or on the sealing tool, or that the temperature sensors are arranged differently in each segment, for example are arranged in an evenly distributed manner in one segment, are arranged in an unevenly distributed manner in a further segment, etc. Further arrangements of temperature sensors which appear expedient to a person skilled in the art and which can be used in particular for the determination of a sealing quality are likewise conceivable. By means of the implementation according to the invention, the test parameter can be evaluated advantageously in a simple manner. In particular, position-precise determination, in particular of temperature fluctuations or temperature differences in different regions, can advantageously be made possible.

It is further proposed, in particular in at least one embodiment of the sealing device according to the invention, that the test unit comprises a computing unit, in particular the computing unit already mentioned above, for evaluating the test parameter detected by means of the temperature sensor, wherein the computing unit is configured to evaluate a temporal progression of the test parameter in order to determine the sealing quality. It is conceivable that the sealing device, in order to achieve the object of permitting structurally simple and reliable determination of a sealing quality, is realized in an alternative embodiment independently of the arrangement of the temperature sensor in a sensor material recess. Preferably, the sealing device in the alternative embodiment, in particular in the embodiment realized independently of the arrangement of the temperature sensor in a sensor material recess, comprises at least one sealing unit for a force and/or energy transmission, generating a sealing, to a container, and at least one test unit, integrated at least partly in the sealing unit, for monitoring a sealing quality of the container sealed by the sealing unit, wherein the test unit comprises at least one temperature sensor for detecting a sealing temperature, wherein the test unit comprises a computing unit, in particular the computing unit already mentioned above, for evaluating the test parameter detected by means of the temperature sensor, wherein the computing unit is configured to evaluate a temporal progression of the test parameter in order to determine the sealing quality. It is conceivable that the computing unit is configured to evaluate a temporal progression of the test parameter in dependence on values of the test parameter which have been detected by means of a single temperature sensor, or that the computing unit is configured to evaluate a temporal progression of the test parameter in dependence on values of the test parameter which have been detected by means of a plurality of temperature sensors. By means of the implementation according to the invention, precise fault recognition can advantageously be made possible. In addition, a prognosis function can advantageously be made possible.

It is further proposed, in particular in at least one embodiment of the sealing device according to the invention, that the test unit has at least one proofing unit at least for proofing an accommodating space of the sealing unit in which at least the temperature sensor is arranged. It is conceivable that the sealing device, in order to achieve the object of permitting a structurally simple and reliable determination of a sealing quality, is realized in an alternative embodiment independently of the arrangement of the temperature sensor in a sensor material recess. Preferably, the sealing device in the alternative embodiment, in particular in the embodiment realized independently of the arrangement of the temperature sensor in a sensor material recess, comprises at least one sealing unit for a force and/or energy transmission, generating a sealing, to a container, and at least one test unit, integrated at least partly in the sealing unit, for monitoring a sealing quality of the container sealed by the sealing unit, wherein the test unit comprises at least one temperature sensor for detecting a sealing temperature, wherein the test unit has at least one proofing unit at least for proofing an accommodating space of the sealing unit in which at least the temperature sensor is arranged. Preferably, the proofing unit comprises at least one, in particular ceramics, feedthrough element for the feedthrough of electrical lines, in particular of the heating unit or of the temperature sensor. In particular, the proofing unit comprises for each temperature sensor a separate feedthrough element, associated with the temperature sensor, for the feedthrough of a line of the respective temperature sensor for connection to the computing unit and/or to a power supply. The proofing unit comprises at least one cable guide element, such as, for example, a cable sleeve or the like, in particular arranged on the feedthrough element, for guiding a line, arranged in the feedthrough element, of the heating unit and/or of the temperature sensor out of the feedthrough element, wherein the cable guide element preferably has a proofing or strain-relief function. The proofing unit preferably comprises at least one proofing element which is arranged at an interface between the sealing holder and the sealing tool, in particular for proofing the accommodating space delimited by the sealing holder and the sealing tool. Preferably, the proofing unit comprises a plurality of proofing elements, in particular in dependence on a number of contact lines/points between the sealing holder and the sealing tool, which are arranged at an interface between the sealing holder and the sealing tool. By means of the implementation according to the invention, reliable operation of the sealing device in a humid operating environment can advantageously be made possible, wherein a reliable determination of the sealing quality can be achieved.

There is additionally proposed a sealing station, in particular for a filling and/or production system, which comprises at least one, in particular the already mentioned, sealing device, at least one sealing carrier for a support of the at least one sealing device, in particular multiple sealing devices, and at least one sealing support for supporting the container, in particular multiple containers, during sealing. The filling and/or production system comprises in particular at least one filling station for filling the containers with the material to be packaged. Optionally, the filling and/or production system comprises at least one production station for producing, processing or preparing the material to be packaged and/or the container. The filling and/or production system preferably comprises at least one conveyor system, in particular a belt conveyor system, for transporting the containers with the packaged material at least from the filling station to the sealing station. The filling station or a further station of the filling and/or production system is configured to arrange, in particular place, the container lid on the receiving unit filled with the packaged material. The sealing station preferably comprises a frame unit, for arranging the sealing station on the conveyor system. The sealing support and the sealing carrier are preferably fastened to the frame unit. Preferably, the sealing support is configured to support the conveyor system which transports the containers and/or to orient the frame unit on the conveyor system, in particular so that the container assumes a pre-set sealing position relative to the sealing carrier when the conveyor system stops. The sealing carrier has in particular at least one sealing head holder for holding, in particular for the suspension of, the sealing device. The sealing carrier is configured in particular to match the sealing device and the sealing position of the container to one another. Preferably, the sealing carrier has multiple sealing head holders for holding multiple, in particular structurally identical, sealing devices. The sealing devices can be arranged side by side relative to an intended transport direction of the containers through the sealing station, in particular for containers transported by means of multiple parallel conveyor systems of the filling and/or production systems, and/or one behind the other, in particular for containers transported by means of the same conveyor system. The sealing devices can be realized so as to be actuatable individually or as a group. By means of the implementation according to the invention, sealing of the containers and checking of the sealing can advantageously be carried out with the same station. In particular, a separate container checking station following sealing can be omitted. In particular, an overall length and a throughput time of a filling and/or production system, which uses the sealing device, for filling the containers with the material to be packaged can thus advantageously be kept short.

There is further proposed a method for operating a sealing device according to the invention and/or a sealing station according to the invention, wherein, while sealing is being carried out by the sealing unit, the test unit captures at least one test parameter in order to determine the sealing quality. The method comprises in particular a pre-processing phase, at least one force and/or energy transmission step, and a post-processing phase. The pre-processing phase preferably comprises at least one contacting step, in which the drive element moves the sealing holder in the direction of the container until the energy and/or force transmission element and/or the sealing tool touches the container. In the energy and/or force transmission step, the force and/or energy transmission element, optionally by way of the sealing tool, transmits force and/or energy to the container in order to join the receiving unit and the container lid together by material bonding. The post-processing phase comprises at least one return step, in which the sealing holder is moved away from the sealed container and back into a starting position of the sealing holder. Detection of the test parameter by the sensor element can be carried out during or overlapping with the energy transmission step and/the post-processing phase. Optionally, the sensor element records at least one comparison value in the pre-processing phase for determining the test parameter. The pre-processing phase and/or the post-processing phase comprises in particular at least one regulation step, in which an actual value of an operating parameter, in particular of the test parameter, of the sealing device is checked and readjusted if it deviates from a target value. For example, in the regulation step, a temperature of the energy and/or force transmission element and/or of the sealing tool is brought in line with a temperature starting value by means of the temperature sensor. For example, the pressure of the pneumatic cylinder is brought in line with the pressure standard by means of the applied-pressure sensor in the regulation step. The regulation step preferably takes place before, in particular before completion of, the contacting step or after, in particular after the start of, the return step. The sensor element and/or the computing unit are/is in particular configured to detect or to determine during or after the energy and/or force transmission step a deviation of the test parameter from a starting value of the test parameter before the energy and/or force transmission step. In particular, the method comprises an evaluation step, in which the computing unit evaluates the test parameter. By means of the implementation according to the invention, the test parameter can advantageously be detected during sealing. In particular, sealing and a check of the sealing can be carried out in an advantageously short time.

It is further proposed that, in one method step of the method, the sealing quality of the container is determined in dependence on a value of the test parameter of a further container. The further container can have been sealed before the container, can be sealed after the container, or can be sealed at the same time as or overlapping in time with the container. In particular, in the evaluation step the computing unit compares the values of the test parameter which have been detected or determined during sealing of the container and of the further container in order to determine the sealing quality of the container. In particular, the computing unit determines a deviation of the test parameters for the containers from one another. Preferably, the computing unit starts a fault diagnosis step if the values of the test parameter for different containers differ from one another by more than a tolerance value. Preferably, in the evaluation step the computing unit determines, on the basis of the values of the test parameter for multiple containers, a target value for the test parameter, in particular in the form of a weighted or unweighted mean, a median, a sliding average or the like. In particular, the computing unit starts the fault diagnosis step if the value of the test parameter differs from the target value for the test parameter. By means of the implementation according to the invention, the test parameter can advantageously be evaluated in a simple manner. In particular, precise and time-consuming calibration of the sealing device can advantageously be omitted.

It is further proposed that, in one method step of the method, the sealing quality is determined in dependence on a comparison of two values of the test parameter which are detected in at least two different measurement points associated with the same container. The different measurement points are in particular associated with the segments of the sealing zone. In particular, the computing unit determines whether different values of the test parameter are detected in the different segments of the sealing zone. Preferably, the computing unit starts the fault diagnosis step if the values of the test parameter for different measurement points differ from one another by more than a tolerance value. By means of the implementation according to the invention, the test parameter can advantageously be evaluated in a simple manner. In particular, precise and time-consuming calibration of the sealing device can advantageously be omitted.

It is further proposed that, in one method step of the method, a temporal progression of the test parameter is evaluated in order to determine the sealing quality. For example, a cooling process of the energy and/or force transmission element and/or of the sealing tool is detected during the energy and/or force transmission step. For example, a pressure change within the pneumatic cylinder is detected during the energy and/or force transmission step. For example, a cooling process of the container is detected in the post-processing step. In particular, the test unit records as the progression at least a start value, an end value and an intermediate value, detected between the start value and the end value, of the test parameter. Optionally, the progression comprises more than 10, in particular more than 100, measurement points per sealed container. The progression can be evaluated in particular in respect of the position and functional value of extremes, points of inflection, an edge steepness, asymptotic behavior and/or the like. The computing unit can evaluate the progression in particular analytically or can compare it with reference progressions stored in the memory of the computing unit. By means of the implementation according to the invention, a large number of indices for determining a fault source in the case of defective sealing can advantageously be determined. In particular, an advantageously precise fault pattern can be prepared.

The sealing device according to the invention, the sealing station according to the invention and/or the method according to the invention are/is not to be limited to the application and embodiment described above. In particular, the sealing device according to the invention, the sealing station according to the invention and/or the method according to the invention can have a number of individual elements, components and units and method steps which differs from a number mentioned herein in order to fulfil a functionality described herein. In addition, in the case of the value ranges indicated in this disclosure, values lying within the mentioned ranges are also to be considered to be disclosed and usable as desired.

### BRIEF DESCRIPTION OF THE DRAWINGS

Further advantages will become apparent from the following description of the drawing. In the drawing, eleven exemplary embodiments of the invention are shown. The drawing, the description and the claims contain numerous features in combination. A person skilled in the art will expediently also consider the features individually and combine them to form expedient further combinations.

In the drawing:

FIG. 1 shows a schematic representation of a sealing station according to the invention,

FIG. 2 shows a schematic representation of a sealing device according to the invention,

FIG. 3 shows a schematic representation of a, in particular ceramics, heating unit of the sealing device according to the invention,

FIG. 4 shows a schematic, perspective sectional representation of the sealing device according to the invention,

FIG. 5 shows a schematic flow diagram of a method for producing the sealing device according to the invention,

FIG. 6 shows a schematic flow diagram of a method according to the invention for operating the sealing device according to the invention,

FIG. 7 shows a schematic, perspective sectional representation of a further embodiment of a sealing device according to the invention having an insulating element,

FIG. 8 shows a schematic representation of another embodiment of a sealing device according to the invention,

FIG. 9 shows a schematic, perspective sectional representation of an alternative embodiment of a sealing device according to the invention, in which a centering unit is at the same time realized as a mount for a, in particular ceramics, heating unit,

FIG. 10 shows a schematic representation of the alternative embodiment of the sealing device according to the invention, looking at a sealing tool of this sealing device according to the invention,

FIG. 11 shows a schematic representation of a further alternative embodiment of a sealing device according to the invention having a, in particular ceramics, heating unit embedded in a sealing holder,

FIG. 12 shows a schematic, perspective sectional representation of the further alternative embodiment of the sealing device according to the invention,

FIG. 13 shows a schematic representation of an alternative ceramics heating unit of a sealing device according to the invention,

FIG. 14 shows a schematic representation of a further alternative, in particular ceramics, heating unit of a sealing device according to the invention,

FIG. 15 shows a schematic representation of a, in particular ceramics, heating unit, realized in a different way, of a sealing device according to the invention,

FIG. 16 shows a schematic, perspective sectional representation of an alternative embodiment of the sealing device according to the invention, and

FIG. 17 shows the sealing device according to the invention of FIG. 16 with an alternative arrangement of a temperature sensor in a schematic representation.

### DETAILED DESCRIPTION

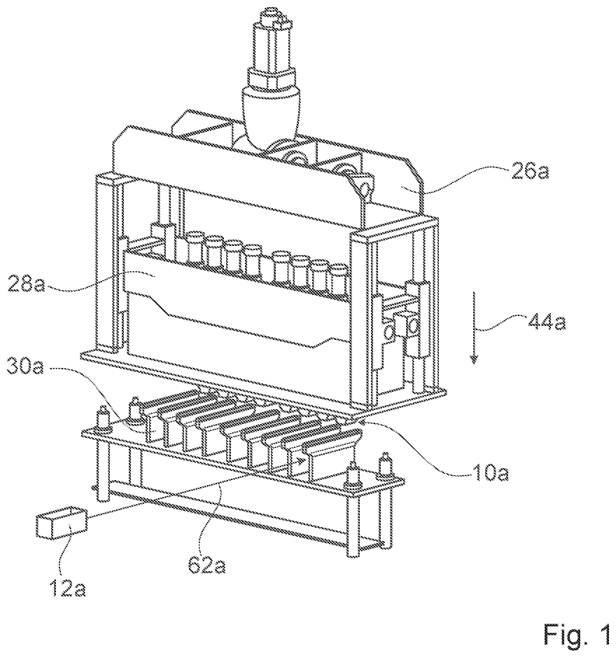

FIG. 1 shows a sealing station 26a. The sealing station 26a is configured in particular for a filling and/or production system. The sealing station 26a comprises at least one sealing device 10a for sealing a container 12a. The container 12a is transported in an intermittent manner through the sealing station 26a, preferably in a transport direction 62a, by a conveyor system of the filling and/or production system, wherein the container 12a is stopped in particular at a sealing position inside the sealing station 26a in order to carry out sealing of the container 12a. Preferably, the sealing station 26a comprises multiple, here for example eight, in particular structurally identical, sealing devices 10a. The sealing devices 10a are arranged in particular parallel with respect to the transport direction 62a of the container 12a through the sealing station 26a, in particular for the parallel sealing of multiple containers 12a. The sealing station 26a comprises at least one sealing carrier 28a for the support of at least the one sealing device 10a, preferably multiple, in particular all, sealing devices 10a of the sealing station 26a. The sealing station 26a comprises a sealing support 30a for supporting the container 12a, in particular multiple containers 12a simultaneously, during sealing. The sealing station 26a preferably has at least one operating mode, in which sealing is carried out in a fully automated manner by the sealing station 26a. Optionally, the sealing station 26a comprises at least one input and/or output unit, in particular at least one display, for checking sealing and/or for adjustment of a processing parameter of the sealing station 26a by a user.

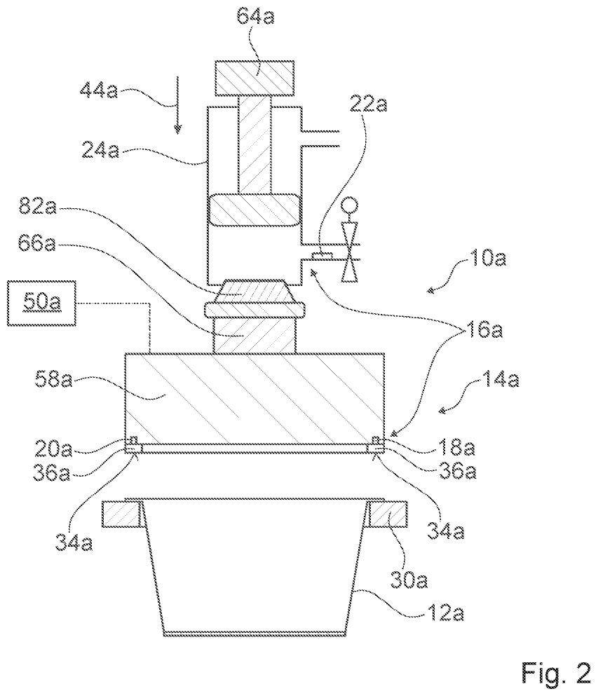

FIG. 2 shows a sectional representation of the sealing device 10a, in particular in a plane perpendicular to the transport direction 62a. The sealing device 10a is in particular a sealing head. The sealing device 10a is configured to seal the container 12a. The sealing device 10a is configured to seal the container 12a by applying a container lid to a receiving unit of the container 12. The sealing device 10a comprises at least one sealing unit 14a for a force and/or energy transmission, generating a sealing, to the container 12a. The sealing device 10a, in particular the sealing unit 14a, comprises at least one sealing tool 34a. The sealing tool 34a forms an annular sealing zone for physical contact with the container 12a. The sealing device 10, in particular the sealing unit 14a, comprises at least one, in particular ceramics, heating unit 36a as a force and/or energy transmission element for heating the sealing zone in order to generate a sealing. The sealing device 10a, in particular the sealing unit 14a, comprises a sealing holder 58a for holding the, in particular ceramics, heating unit 36a. The, in particular ceramics, heating unit 36a forms at least part of the sealing tool 34a having the sealing zone for direct contact with the container 12a.

The sealing device 10a, in particular the sealing unit 14a, comprises at least one drive element 64a, in particular a servo motor. The drive element 64a is preferably coupled mechanically, hydraulically and/or pneumatically with the sealing holder 58a. The drive element 64a is configured in particular to displace the sealing holder 58a together with the sealing tool 34a fastened thereto in a sealing direction 44a of the sealing device 10a, in particular in order to bring the sealing tool 34a into physical contact with the container 12a. The sealing direction 44a is preferably at least substantially perpendicular to the transport direction 62a of the container 12a. The, in particular ceramics, heating unit 36a is arranged in particular on a side of the sealing holder 58a that is remote from the drive element 64a.

The sealing device 10a comprises at least one test unit 16a integrated at least partly in the sealing unit 14a. The test unit 16a is configured to monitor a sealing quality of the container 12a sealed by the sealing unit 14a. The test unit 16a comprises at least one temperature sensor 18a for detecting a sealing temperature. The test unit 16a comprises at least one further temperature sensor 20a for spatially resolved detection of the sealing temperature. The temperature sensor 18a and/or the further temperature sensor 20a are preferably arranged on the, in particular ceramics, heating unit 36a and/or on the sealing tool 34a. The test unit 16a comprises at least one applied-pressure sensor 22a for detecting a sealing force and/or a sealing pressure. The test unit 16a comprises a pneumatic cylinder 24a in or on which the applied-pressure sensor 22a is arranged. The pneumatic cylinder 24a is arranged in particular between the drive element 64a and the sealing holder 58a. By way of example, the drive element 64a is coupled with a piston of the pneumatic cylinder 24a, wherein a cylinder housing of the pneumatic cylinder 24a, which holds the piston, is connected directly or indirectly by way of a transmission unit 66a of the sealing unit 14a to the sealing holder 58a. Alternatively, the drive element 64a is coupled with the cylinder housing of the pneumatic cylinder 24a and the piston of the pneumatic cylinder 24a is coupled directly or by way of the transmission unit 66a of the sealing unit 14a with the sealing holder 58a. The applied-pressure sensor 22a is arranged in particular in a feed line to the cylinder housing of the pneumatic cylinder 24a. The applied-pressure sensor 22a is arranged in particular in a volume of the pneumatic cylinder 24a that is closed during sealing, and is configured in particular to measure a gas pressure inside the pneumatic cylinder 24a during sealing.

The sealing device 10a comprises a control or regulation unit 50a for a regulation or controlling of a temperature of the, in particular ceramics, heating unit 36a. The control or regulation unit 50a is configured in particular to set or adjust the sealing temperature via the temperature of the, in particular ceramics, heating unit 36a. The control or regulation unit 50a is configured in particular for the controlling or regulation of the drive element 64a. The control or regulation unit 50a is configured in particular to set or adjust the sealing force and/or the sealing pressure.

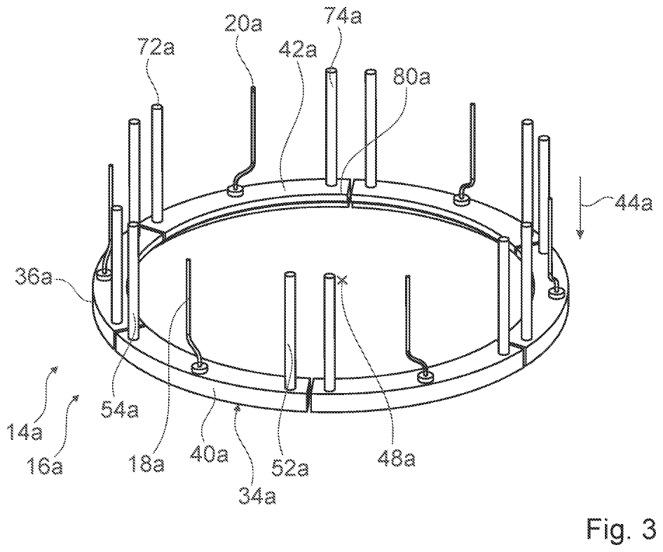

FIG. 3 shows the, in particular ceramics, heating unit 36a. The, in particular ceramics, heating unit 36a comprises a heating conductor (not shown in detail here) which, in a heating region of the, in particular ceramics, heating unit 36a, is surrounded at least substantially completely by a heat-conducting, in particular ceramics, base body 40a of the, in particular ceramics, heating unit 36a. The at least one, in particular ceramics, base body 40a is manufactured from silicon nitride or aluminum nitride. The heating conductor is preferably manufactured from silicon nitride or aluminum nitride which has been provided with an additive in order to increase the electrical conductivity with respect to the, in particular ceramics, base body 40a. The additive accounts for in particular less than 50%, preferably less than 25%, of the total mass of the heating conductor. The, in particular ceramics, heating unit 36a preferably comprises electrical connectors 52a, 54a via which the heating conductor is electrically connected in particular to the control or regulation unit 50a. The electrical connectors 52a, 54a run in particular at least substantially parallel to the sealing direction 44a. The at least one, in particular ceramics, base body 40a forms at least part of the sealing tool 34a having the sealing zone for direct contact with the container 12a. The sealing zone is here in particular annular. The electrical connectors 52a, 54a are arranged in particular on a side of the, in particular ceramics, base body 40a that is remote from the sealing tool 34a.

The, in particular ceramics, heating unit 36a comprises at least one further, here for example five further, in particular ceramics, base bodies 42a. The further, in particular ceramics, base body 42a is formed separately from the, in particular ceramics, base body 40a. The further, in particular ceramics, base body 42a is in particular structurally identical to the, in particular ceramics, base body 40a. The, in particular ceramics, base body 40a and the further, in particular ceramics, base body 42a each form in particular a partial segment of the sealing zone. The, in particular ceramics, base body 40a and the further, in particular ceramics, base body 42a are arranged in a plane perpendicular to a sealing direction 44a at an at least substantially equal distance from a geometric center point 48a of the, in particular ceramics, heating unit 36a, in particular of the annular sealing zone. The, in particular ceramics, heating unit 36a comprises in particular a further heating conductor inside the further, in particular ceramics, base body 42a. The further heating conductor is preferably formed separately from the heating conductor and is electrically connected in particular via further electrical connectors 72a, 74a of the, in particular ceramics, heating unit 36a in particular to the control or regulation unit 50a. The further electrical connectors 72a, 74a are preferably formed inside the sealing unit 14a separately from the electrical connectors 52a, 54a of the heating conductor. The control or regulation unit 50a is configured for the separate controlling or regulation of a temperature of the various, in particular ceramics, base bodies 40a, 42a. The control or regulation unit 50a can comprise multiple independent current and/or voltage sources and/or switching elements for distributing an electrical current flow of a current and/or voltage source to the various electrical connectors 52a, 54a, 72a, 74a. Depending on the application, the further electrical connectors 72, 74a and the electrical connectors 52a, 54a can be connected electrically separately from one another to the control or regulation unit 50a or can be connected in parallel or in series with one another. In particular, at least one of the temperature sensors 18a, 20a is allocated to each, in particular ceramics, base body 40a, 42a which surrounds one of the heating conductors. In particular, the temperature sensor 18a is arranged in a sensor material recess of the, in particular ceramics, base body 40a. In particular, the further temperature sensor 20a is arranged in a sensor material recess of the further, in particular ceramics, base body 42a. The sensor material recesses are preferably arranged on the same side of the, in particular ceramics, base bodies 40a, 42a as the respective electrical connectors 52a, 54a, 72a, 74a.

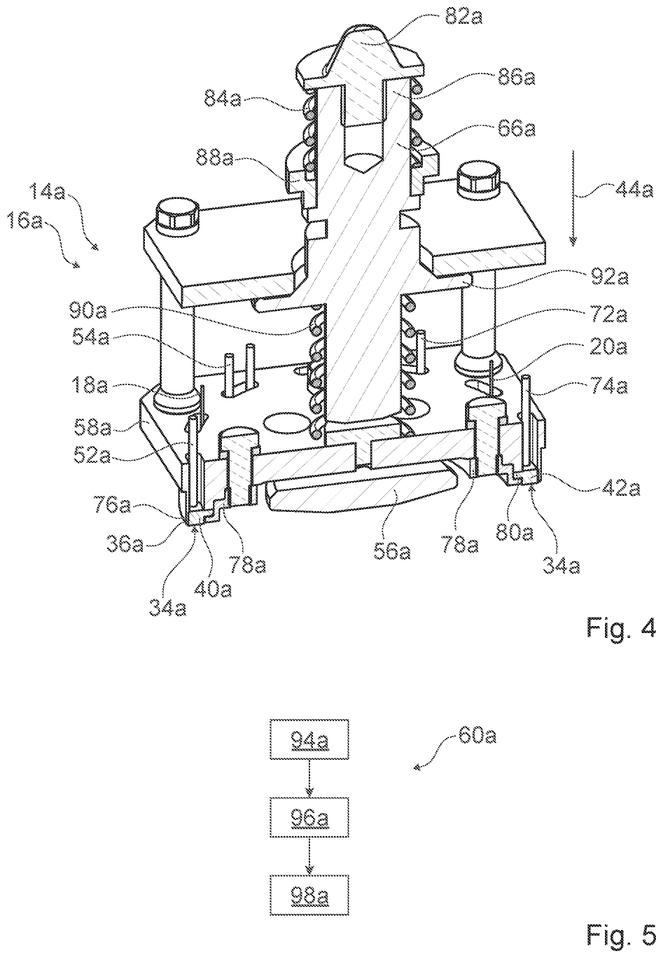

FIG. 4 shows a sectional representation of the sealing device 10a in a plane parallel to the sealing direction 44a. The sealing holder 58a comprises in particular a plate-shaped base body which preferably comprises more than 50%, in particular more than 75%, of a total volume of the sealing holder 58a. The sealing holder 58a is preferably manufactured from metal, in particular stainless steel. The sealing holder 58a preferably has a holding structure 76a which is configured in particular to hold the, in particular ceramics, heating unit 36a by positive engagement in a direction perpendicular to the sealing direction 44a. The holding structure 76a projects in particular from the plate-shaped base body of the sealing holder 58a. The holding structure 76a is of annular form, for example, and surrounds the, in particular ceramics, heating unit 36a in a plane perpendicular to the sealing direction 44a. The sealing device 10a preferably comprises a mount 78a. The mount 78a is configured in particular to fix the, in particular ceramics, heating unit 36a to the sealing holder 58a by positive engagement in a direction parallel to the sealing direction 44a. For example, the mount 78 is in the form of a holding ring. The mount 78a is preferably manufactured from metal, in particular a stainless steel. A maximum transverse extent, in particular outside diameter, of the mount 78a perpendicular to the sealing direction 44a is in particular smaller than a maximum transverse extent of the, in particular ceramics, heating unit 36a. Preferably, the, in particular ceramics, base bodies 40a, 42a of the, in particular ceramics, heating unit 36a form a projection 80a which in particular is arranged spaced apart from that side of the corresponding, in particular ceramics, base body 40a, 42a that faces the sealing tool 34a and/or that forms the sealing tool 34a. The projection 80a is arranged in particular on a side of the, in particular ceramics, base body 40a, 42a that faces the geometric center point 48a of the, in particular ceramics, heating unit 36a. In particular, the projection 80a is arranged, in particular clamped, parallel to the sealing direction 44a between the sealing holder 58a, in particular the plate-shaped base body of the sealing holder 58a and/or a contact structure of the sealing holder 58a projecting from the plate-shaped base body, and the mount 78a. The mount 78a is fixed to the sealing holder 58a in particular by means of screws projecting through the sealing holder 58a. The sealing holder 58a preferably has connector material recesses through which the electrical connectors 52a, 54a, 72a, 74a and connectors for the temperature sensors 18a, 20a are guided from the, in particular ceramics, heating unit 36a through the sealing holder 58a.

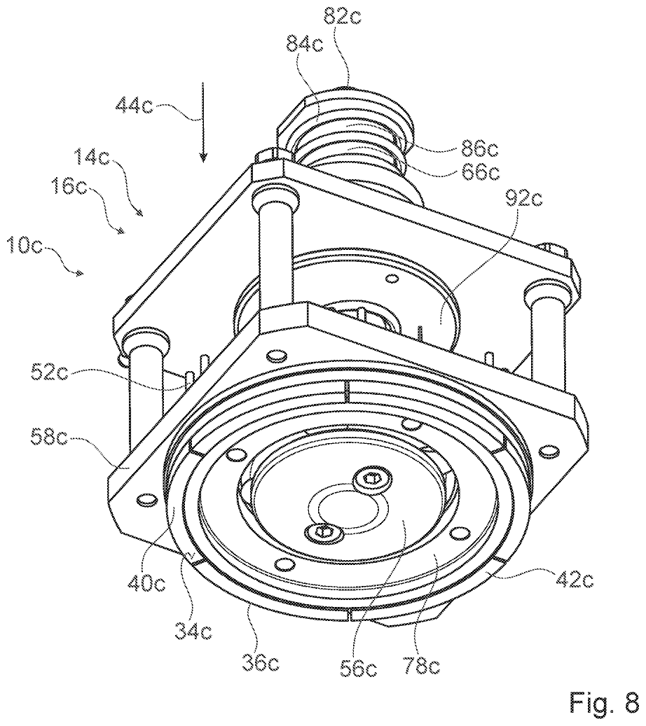

The sealing device 10a comprises a centering unit 56a for securing the container 12a during a sealing operation. The centering unit 56a is in particular in the form of a curved disk. The centering unit 56a is arranged in particular inside the, in particular ceramics, heating unit 36a and in particular inside the mount 78a in a plane perpendicular to the sealing direction 44a. In particular, the centering unit 56a is arranged concentrically with the, in particular ceramics, heating unit 36a and in particular with the mount 78a. A curvature of the centering unit 56a is realized parallel to the centering unit 56a in particular away from the sealing holder 58a, and in particular facing the container 12. The centering unit 56a is in particular screwed to the sealing holder 58a (see in this connection FIG. 8).

The transmission unit 66a comprises, for example, a rigid transmission rod 86a which is configured in particular to transmit force and/or pressure from the drive element 64a via the pneumatic cylinder 24a to the sealing holder 58a. A maximum longitudinal extent of the transmission rod 86a is arranged in particular at least substantially parallel to the sealing direction 44a. In particular, the transmission unit 66a comprises a conical attachment 82a which is arranged at an end of the transmission rod 86a that is remote from the sealing holder 58a. The conical attachment 82a is preferably surrounded by the cylinder housing of the pneumatic cylinder 24a in a plane perpendicular to the sealing direction 44a. Preferably, the transmission unit 66a comprises at least one spring 84a which is arranged around the transmission rod 86a and which engages the conical attachment 82a and a bearing 88a of the transmission unit 66a. The bearing 88a is preferably configured for insertion of the sealing device 10a into the sealing carrier 28a. Preferably, the transmission unit 66a comprises at least one further spring 90a which is arranged around the transmission rod 86a and which engages the sealing holder 58a and a stop element 92a of the transmission rod 86a. The stop element 92a in particular defines a neutral position of the transmission rod 86a in which in particular no force and/or pressure is transmitted from the drive element 64a to the container 12a, even if the sealing tool 34a is in physical contact with the container 12a. Preferably, the transmission rod 86a is arranged spaced apart from the sealing holder 58a at least in the neutral position.

FIG. 5 shows a method 60a for producing the sealing device 10a. The method 60a for producing the sealing device 10a preferably comprises an adaptation step 94a. In the adaptation step 94a, a, in particular standardized, pre-product of the, in particular ceramics, heating unit 36a, in particular of the, in particular ceramics, base bodies 40a, 42a, is preferably prepared. In the pre-product, the, in particular ceramics, base body 40a, 42a is in particular in an already cured state, in particular a fully cured state, in particular as a result of sintering. In the at least one adaptation step 94a of the method 60a for producing the sealing device 10a, the at least one, in particular ceramics, base body 40a, 42a in a cured state of the, in particular ceramics, base body 40a, 42a is adapted to an intended container geometry of the container 12a by material removal. In particular, a material thickness of the pre-product in a direction perpendicular to the sealing direction 44a is reduced to an intended material thickness of the, in particular ceramics, base body 40a, 42a in that direction. The intended material thickness is preferably equal to a width of an intended sealing surface of the container 12a.

The method 60a for producing the sealing device 10a preferably comprises a sensor introduction step 96a. In the sensor introduction step 96a of the method 60a for producing the sealing device 10a, the at least one, in particular ceramics, base body 40a, 42a is in a cured state of the, in particular ceramics, base body 40a, 42a. In the sensor introduction step 96a, in particular at least one sensor material recess is produced, in particular drilled, in the, in particular ceramics, base body 40a, 42a. Alternatively, the sensor material recess is produced in the, in particular ceramics, base body 40a, 42a in or before the adaptation step 94a. In the sensor introduction step 96a, the temperature sensor 18a, 20a is introduced into the sensor material recess, in particular a drilled hole, of the at least one cured, in particular ceramics, base body 40a, 42a. Optionally, the sensor material recess is filled and/or closed with a curable material after the temperature sensor 18a, 20a has been introduced.

The method 60a for producing the sealing device 10a comprises in particular an assembly step 98a. In the assembly step 98a, the, in particular ceramics, heating unit 36a is arranged on the sealing holder 58a, and placed on the holding structure 76a in particular along the holding structure 76a. In particular, the individual, in particular ceramics, base bodies 40a, 42a are arranged along at least one closed path which runs in a plane perpendicular to the sealing direction 44a. Preferably, the, in particular ceramics, base bodies 40a are arranged along the at least one closed path spaced apart from one another by only a small distance. The small distance preferably corresponds to a maximum expected thermal expansion of the, in particular ceramics, base bodies 40a, 42a along the path at the sealing temperature, in particular including a safety factor. The, in particular ceramics, heating unit 36a is secured to the sealing holder 58a in particular by the mount 78a.

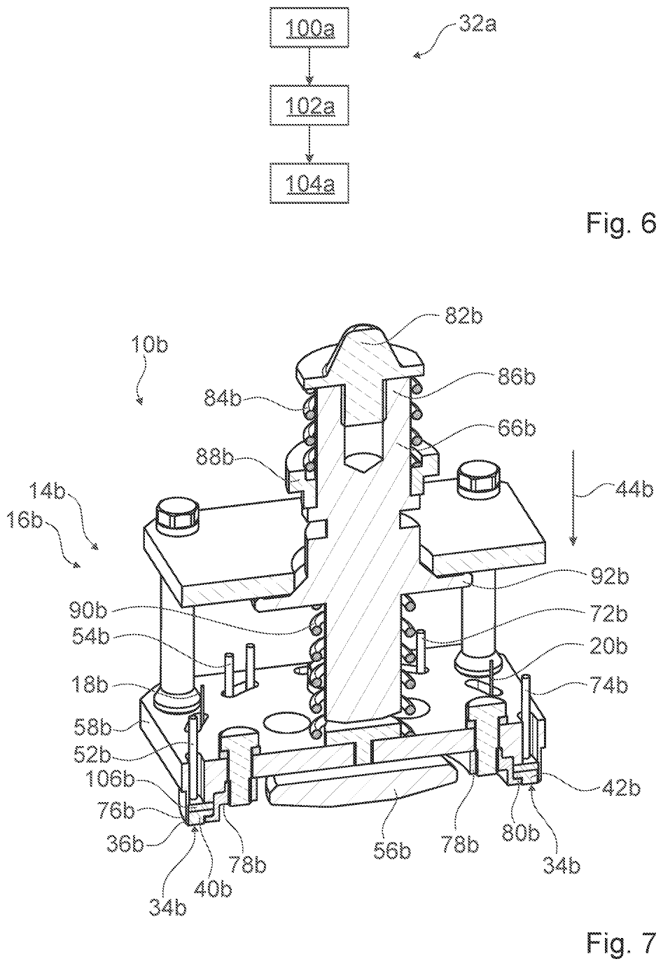

FIG. 6 shows a method 32a for operating the sealing device 10a and/or a sealing station 26a. The method 32a for operating the sealing device 10a preferably comprises a detection step 100a. The detection step 100a is carried out in particular during sealing of the container 12a. While sealing is being carried out by the sealing unit 14a, the test unit 16a captures at least one test parameter in order to determine the sealing quality. The detection step 100a can begin before sealing and/or can continue beyond the end of sealing, in particular in order to capture comparison values for a test value of the test parameter detected during sealing. The test parameter is preferably the sealing temperature of the, in particular ceramics, heating unit 36a, which is detected in particular by the temperature sensors 18a, 20a of the test unit 16a. Particularly preferably, the test unit 16a detects a specific sealing temperature for multiple, in particular each, in particular ceramics, base body 40a, 42a by means of the temperature sensors 18a, 20a. Preferably, the test unit 16a comprises a computing unit (not shown in detail here) for evaluating the test parameter detected by means of the temperature sensors 18a, 20a. Preferably, the computing unit is configured to determine the sealing quality in dependence on a comparison of two values of the test parameter which are detected in at least two different measurement points associated with the same container 12a. Alternatively or in addition, the computing unit is configured to evaluate a temporal progression of the test parameter in order to determine the sealing quality. Preferably, the test unit 16a detects as an additional or alternative test parameter a sealing pressure measured by the applied-pressure sensor 22a. The comparison value and/or the test value of the respective test parameter can be detected in particular as a single value, in particular as a random sample and/or temporal mean, as a series of values or as an almost continuous temporal progression.

The method 32a for operating the sealing device 10a preferably comprises an evaluation step 102a. The evaluation step 102a is carried out in particular by the computing unit of the test unit 16a. Optionally, the computing unit processes raw data relating to the test parameter which have been detected by the temperature sensors 18a, 20a and/or the applied-pressure sensor 22a, for example by derivation, integration, averaging, difference determination or the like. The computing unit checks, for example, a temperature drop of the, in particular ceramics, base bodies 40a, 42a during contact with the container 12a in order to determine the sealing quality. The computing unit compares the test parameter(s), for example, with a target value for the test parameter. In the evaluation step 102a, the computing unit determines the sealing quality in dependence on a comparison of two values of the test parameter which are detected in at least two different measurement points associated with the same container 12a. In particular, the computing unit compares a temperature drop of the, in particular ceramics, base body 40a with a temperature drop of the further, in particular ceramics, base body 42a. In particular, the computing unit concludes that the sealing quality is inadequate if the test parameters for the different measurement points differ from one another by more than a, in particular application-dependent, tolerance value.

In the evaluation step 102a, the computing unit determines the sealing quality of the container 12a in dependence on a value of the test parameter of a further container. The further container can be a container which is sealed at the same time as the container 12a by a further sealing device of the sealing station 26a, or a container which has been sealed by the sealing device 10a before the container 12a. In particular, the computing unit concludes that the sealing quality is inadequate if the test parameters for the different containers 12a differ from one another by more than a, in particular application-dependent, tolerance value. Preferably, the computing unit logs the test parameter(s) for a further evaluation at least in the case where the sealing quality is inadequate. In particular, the computing unit determines a possible fault source in the sealing device 10a and/or in an upstream station of the filling and/or production system on the basis of the logged test parameters, for example in dependence on a statistical accumulation, on the basis of a digital model of the sealing device 10a, on the basis of trend curves of the test parameter(s) or the like. Possible fault sources between which the computing unit distinguishes include in particular a defect within the sealing device 10a, for example a defect of one of the temperature sensors 18a, 20a and/or a defect of one of the heating conductors, an incorrect orientation of a container lid relative to a receiving unit of the container 12a, contamination of the container 12a, a bend in the container lid of the container 12, or the like. Criteria for distinguishing between the fault sources can explicitly be stored as comparison values in a memory of the computing unit and/or can have been produced by the computing unit by machine learning.

The method 32a for operating the sealing device 10a preferably comprises an output step 104a. In particular, the test parameter and/or the sealing quality is outputted in the output step 104a. Preferably, the computing unit is part of the control or regulation unit 50a or has at least one data link with that control unit, in particular for the forwarding of the unprocessed test parameter and/or of an instruction, derived from the test parameter, for changed actuation of the sealing unit 14a. In addition or alternatively, in the output step 104a the computing unit outputs the determined sealing quality to a user, for example via the input and/or output unit of the sealing station 26a and/or via an external output device, such as, for example, a smartphone, a tablet, a display in a central system controller of the filling and/or production system, or the like. Optionally, the computing unit is connected for data transfer to a sorting station of the filling and/or production system, in particular in order to automatically separate out containers with inadequate sealing quality.

Further exemplary embodiments of the invention are shown in FIGS. 7 to 17. The following descriptions and the drawings are limited substantially to the differences between the exemplary embodiments, wherein reference may in principle also be made in respect of identically designated components, in particular in relation to components having the same reference signs, to the drawings and/or the description of the other exemplary embodiments, in particular of FIGS. 1 to 6. In order to distinguish between the exemplary embodiments, the letter a has been added to the reference signs of the exemplary embodiment in FIGS. 1 to 6. In the exemplary embodiments of FIGS. 7 to 17, the letter a has been replaced by the letters b to j.

FIG. 7 shows a sealing device 10b. The sealing device 10b is configured to seal a container (not shown in detail here). The sealing device 10b comprises at least one sealing unit 14b for a force and/or energy transmission, generating a sealing, to the container. The sealing device 10b, in particular the sealing unit 14b, comprises at least one sealing tool 34b which forms an annular sealing zone for physical contact with the container. The sealing device 10b, in particular the sealing unit 14b, comprises at least one, in particular ceramics, heating unit 36b for heating the sealing zone in order to generate sealing. The, in particular ceramics, heating unit 36b comprises a heating conductor (not shown in detail here) which, in a heating region of the, in particular ceramics, heating unit 36b, is surrounded at least substantially completely by a heat-conducting, in particular ceramics, base body 40b, 42b of the, in particular ceramics, heating unit 36b. The sealing device 10b comprises at least one test unit 16b, integrated at least partly in the sealing unit 14b, for monitoring a sealing quality of the container sealed by the sealing unit 14b. The sealing device 10b comprises in particular a, in particular heat-insulating, insulating element 106b. The insulating element 106b is preferably manufactured from a heat-insulating material. Preferably, the insulating element 106b, in particular in a direction parallel to a sealing direction 44b of the sealing device 10b, is arranged between the, in particular ceramics, heating unit 36b and a sealing holder 58b of the sealing device 10b. The insulating element 106b is preferably annular. Preferably, the insulating element 106b is additionally arranged, or an additional insulating element of the sealing device 10b is arranged, between the, in particular ceramics, heating unit 36b and a holding structure 76b of the sealing holder 58b. With regard to further features of the sealing device 10b, reference may be made to FIGS. 1 to 6 and the description thereof.

FIG. 8 shows a sealing device 10c. The sealing device 10c is configured to seal a container (not shown in detail here). The sealing device 10c comprises at least one sealing unit 14c for a force and/or energy transmission, generating a sealing, to the container. The sealing device 10c, in particular the sealing unit 14c, comprises at least one sealing tool 34c which forms an annular sealing zone for physical contact with the container. The sealing device 10c, in particular the sealing unit 14c, comprises at least one, in particular ceramics, heating unit 36c for heating the sealing zone in order to generate sealing. The, in particular ceramics, heating unit 36c comprises a heating conductor (not shown in detail here) which, in a heating region of the, in particular ceramics, heating unit 36c, is surrounded at least substantially completely by a heat-conducting, in particular ceramics, base body 40c, 42c of the, in particular ceramics, heating unit 36c. The sealing device 10c comprises at least one test unit 16c, integrated at least partly in the sealing unit 14c, for monitoring a sealing quality of the container sealed by the sealing unit 14c. The, in particular ceramics, heating unit 36c is arranged on a sealing holder 58c of the sealing device 10c so as to be exposed on an outer surface facing away from a geometric center point of the, in particular ceramics, heating unit 36c. In particular, the, in particular ceramics, heating unit 36a is held in a direction perpendicular to a sealing direction 44c of the sealing device 10c solely by a mount 78c of the sealing device 10c, said mount in particular surrounding a projection 80c, facing away from the outer surface, of the, in particular ceramics, base body 40c, 42c. With regard to further features of the sealing device 10c, reference may be made to FIGS. 1 to 7 and the description thereof.

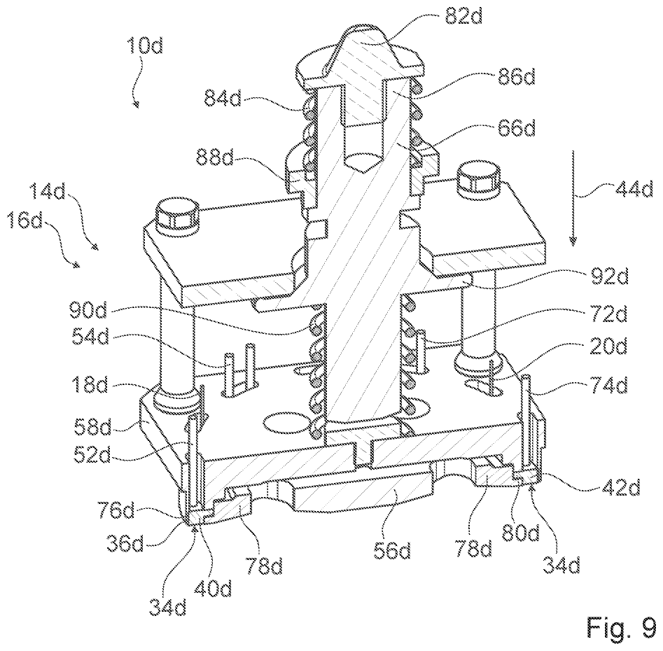

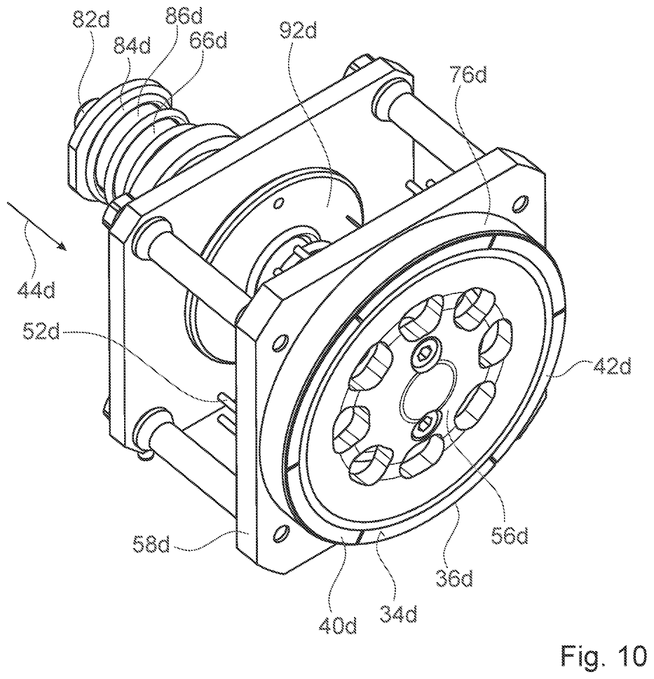

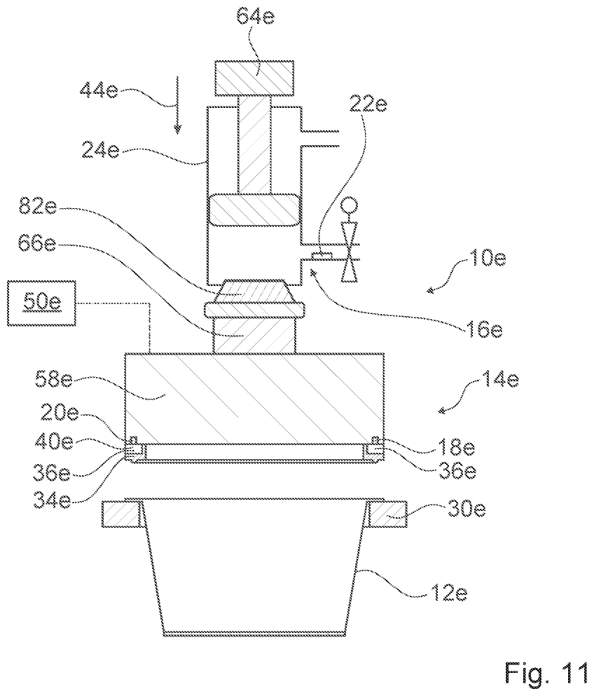

FIGS. 9 and 10 show a sealing device 10d. The sealing device 10d is configured to seal a container (not shown in detail here). The sealing device 10d comprises at least one sealing unit 14d for a force and/or energy transmission, generating a sealing, to the container. The sealing device 10d, in particular the sealing unit 14d, comprises at least one sealing tool 34d which forms an annular sealing zone for physical contact with the container. The sealing device 10d, in particular the sealing unit 14d, comprises at least one, in particular ceramics, heating unit 36d for heating the sealing zone in order to generate sealing. The, in particular ceramics, heating unit 36d comprises a heating conductor (not shown in detail here) which, in a heating region of the, in particular ceramics, heating unit 36d, is surrounded at least substantially completely by a heat-conducting, in particular ceramics, base body 40d, 42d of the, in particular ceramics, heating unit 36d. The sealing device 10d comprises at least one test unit 16d, integrated at least partly in the sealing unit 14d, for monitoring a sealing quality of the container sealed by the sealing unit 14d. The sealing device 10d comprises in particular a mount 78d for fixing the, in particular ceramics, heating unit 36d to a sealing holder 58d of the sealing device 10d. The sealing device 10d preferably comprises a centering unit 56d. The centering unit 56d in particular forms the mount 78d. The centering unit 56d extends in particular beyond an entire material recess of the, in particular ceramics, heating unit 36d. The centering unit 56d is arranged in particular in a direction parallel to a sealing direction 44d of the sealing device 10d so as to overlap the, in particular ceramics, heating unit 36d. The, in particular ceramics, heating unit 36d is arranged by positive engagement between the centering unit 56d and the sealing holder 58d. In particular, a projection 80d of the, in particular ceramics, base body 40d, 42d is arranged in the direction parallel to the sealing direction 44d of the sealing device 10d between a sealing holder 58d of the sealing device 10d and the centering unit 56d. With regard to further features of the sealing device 10d, reference may be made to FIGS. 1 to 8 and the description thereof.

FIG. 11 shows a sealing device 10e. The sealing device 10e is configured to seal a container 12e. The sealing device 10e comprises at least one sealing unit 14e for a force and/or energy transmission, generating a sealing, to the container 12e. The sealing device 10e, in particular the sealing unit 14e, comprises at least one sealing tool 34e which forms an annular sealing zone for physical contact with the container 12e. The sealing device 10e, in particular the sealing unit 14e, comprises at least one, in particular ceramics, heating unit 36e for heating the sealing zone in order to generate sealing. The, in particular ceramics, heating unit 36e comprises a heating conductor (not shown in detail here) which, in a heating region of the, in particular ceramics, heating unit 36e, is surrounded at least substantially completely by a heat-conducting, in particular ceramics, base body 40e of the, in particular ceramics, heating unit 36e. The sealing device 10e comprises at least one test unit 16e, integrated at least partly in the sealing unit 14e, for monitoring a sealing quality of the container 12e sealed by the sealing unit 14e. The sealing tool 34e is in the form of an attachment which is arranged, in particular reversibly, on the, in particular ceramics, base body 40e. The sealing tool 34e is in particular manufactured from metal, in particular stainless steel. The sealing tool 34e is preferably screwed to a sealing holder 58e of the sealing device 10e. Alternatively, the sealing device 10e comprises a mount (not shown here) which is screwed to the sealing holder 58e and fixes the sealing tool 34e to the, in particular ceramics, heating unit 36e by positive engagement. With regard to further features of the sealing device 10e, reference may be made to FIGS. 1 to 10 and the description thereof.

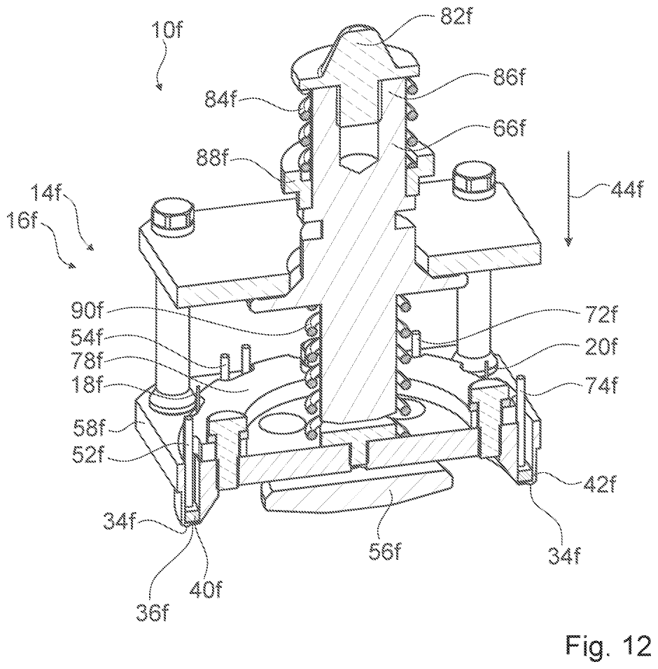

FIG. 12 shows a sealing device 10f. The sealing device 10f is configured to seal a container (not shown in detail here). The sealing device 10f comprises at least one sealing unit 14f for a force and/or energy transmission, generating a sealing, to the container. The sealing device 10f, in particular the sealing unit 14f, comprises at least one sealing tool 34f which forms an annular sealing zone for physical contact with the container. The sealing device 10f, in particular the sealing unit 14f, comprises at least one, in particular ceramics, heating unit 36f for heating the sealing zone in order to generate sealing. The, in particular ceramics, heating unit 36f comprises a heating conductor (not shown in detail here) which, in a heating region of the, in particular ceramics, heating unit 36f, is surrounded at least substantially completely by a heat-conducting, in particular ceramics, base body 40f of the, in particular ceramics, heating unit 36f. The sealing device 10f comprises at least one test unit 16f, integrated at least partly in the sealing unit 14f, for monitoring a sealing quality of the container sealed by the sealing unit 14f. The, in particular ceramics, heating unit 36f is arranged in particular inside a sealing holder 58f of the sealing device. In particular, a side of the sealing holder 58f that is remote from the sealing tool 34f has a depression in which the, in particular ceramics, heating unit 36f is inserted. The sealing device 10f comprises in particular a mount 78f which fixes the, in particular ceramics, heating unit 36f inside the sealing holder 58f, in particular inside the depression, by positive engagement. The mount 78f is preferably arranged on a side of the sealing holder 58f that is remote from the sealing tool 34f on that side. Preferably, the mount 78f engages into the sealing holder 58f, in particular into the depression, in order to fix the, in particular ceramics, heating unit 36f inside the sealing holder 58f, in particular to a base of the depression. The sealing holder 58f forms the sealing tool 34f having the sealing zone. With regard to further features of the sealing device 10f, reference may be made to FIGS. 1 to 11 and the description thereof.

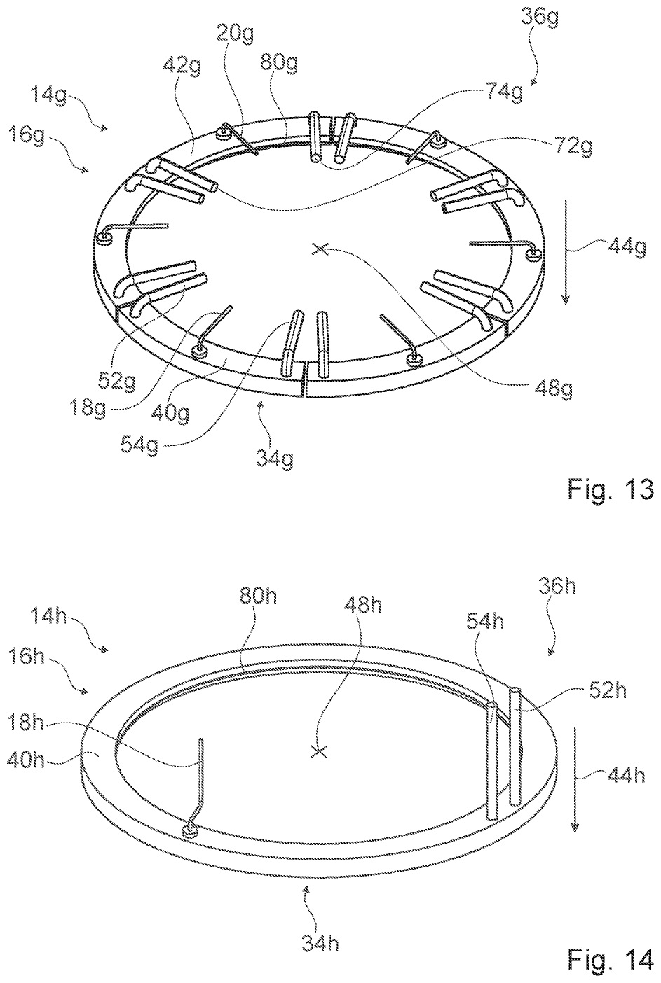

FIG. 13 shows a, in particular ceramics, heating unit 36g for a sealing device as has been described in the preceding paragraphs. The, in particular ceramics, heating unit 36g comprises a heating conductor (not shown in detail here) which, in a heating region of the, in particular ceramics, heating unit 36g, is surrounded at least substantially completely by a heat-conducting, in particular ceramics, base body 40g, 42g of the, in particular ceramics, heating unit 36g. At least one electrical connector, in particular all the electrical connectors 52g, 54g, 72g, 74g, of the, in particular ceramics, heating unit 36g for the heating conductor runs transverse, in particular perpendicular, to a sealing direction 44g of the sealing device. The electrical connectors 52g, 54g, 72g, 74g are oriented in particular on a center axis, running parallel to the sealing direction 44g, of the, in particular ceramics, heating unit 36g and/or of the sealing device, said center axis running through a geometric center point 48g of the, in particular ceramics, heating unit 36g. Preferably, connectors for temperature sensors 18g, 20g of the sealing device, which are arranged in or on the, in particular ceramics, base body 40g, 42g, are arranged and/or oriented analogously thereto. With regard to further features of the, in particular ceramics, heating unit 36g and the arrangement thereof in a sealing device, reference may be made to FIGS. 1 to 12 and the description thereof.

FIG. 14 shows a, in particular ceramics, heating unit 36h for a sealing device as has been described in the preceding paragraphs. The, in particular ceramics, heating unit 36h comprises a heating conductor (not shown in detail here) which, in a heating region of the, in particular ceramics, heating unit 36h, is surrounded at least substantially completely by a heat-conducting, in particular ceramics, base body 40h of the, in particular ceramics, heating unit 36h. In particular, the, in particular ceramics, base body 40h is in the form of a closed ring. In particular, the, in particular ceramics, base body 40h is the only, in particular ceramics, base body 40h of the, in particular ceramics, heating unit 36h. With regard to further features of the, in particular ceramics, heating unit 36h and the arrangement thereof in a sealing device, reference may be made to FIGS. 1 to 13 and the description thereof.

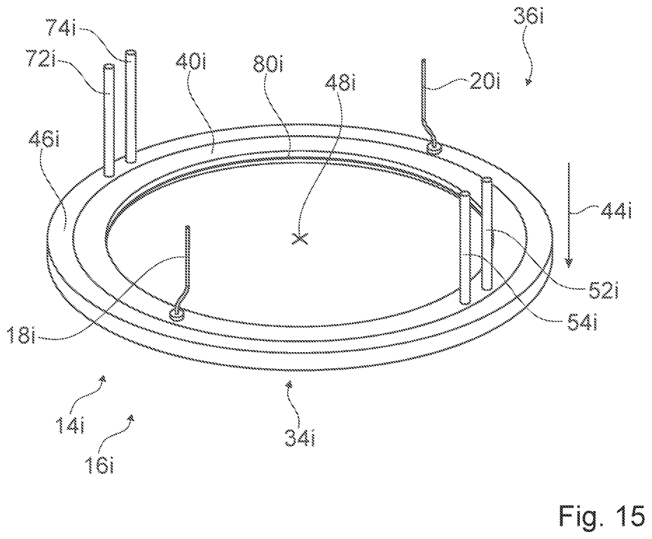

FIG. 15 shows a, in particular ceramics, heating unit 36i for a sealing device as has been described in the preceding paragraphs. The, in particular ceramics, heating unit 36i comprises a heating conductor (not shown in detail here) which, in a heating region of the, in particular ceramics, heating unit 36i, is surrounded at least substantially completely by a heat-conducting, in particular ceramics, base body 40i of the, in particular ceramics, heating unit 36i. The, in particular ceramics, heating unit 36i comprises at least one additional, in particular ceramics, base body 46i. The additional, in particular ceramics, base body 46i is formed separately from the, in particular ceramics, base body 40i. The, in particular ceramics, base body 40i and the additional, in particular ceramics, base body 46i are arranged on different, closed paths around a geometric center point 48i of the, in particular ceramics, heating unit 36i, in particular of an annular sealing zone of the sealing device. The, in particular ceramics, base body 40i and the additional, in particular ceramics, base body 46i are in particular in the form of rings or ring segments which are arranged concentrically with respect to the geometric center point 48i. With regard to further features of the, in particular ceramics, heating unit 36i and the arrangement thereof in a sealing device, reference may be made to FIGS. 1 to 14 and the description thereof.

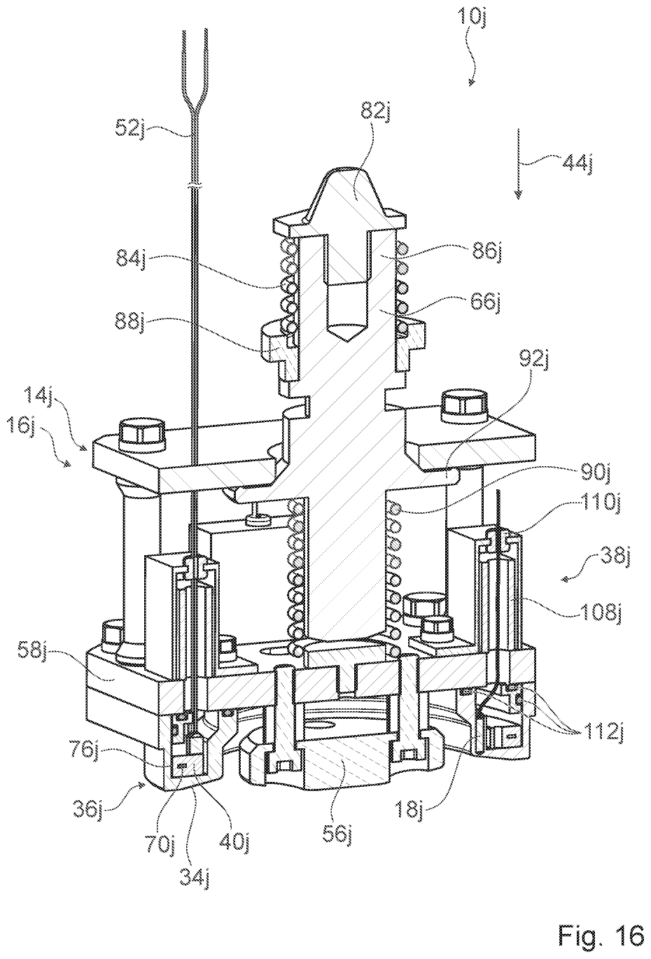

FIG. 16 shows a sectional representation of a sealing device 10j, which in particular is implemented in a different way. The sealing device 10j is configured to seal a container (not shown in detail here). The sealing device 10j comprises at least one sealing unit 14j for a force and/or energy transmission, generating a sealing, to the container. The sealing device 10j, in particular the sealing unit 14j, comprises at least one sealing tool 34j which forms a, in particular annular, sealing zone for physical contact with the container. The sealing device 10j, in particular the sealing unit 14j, comprises at least one, in particular ceramics, heating unit 36j for heating the sealing zone in order to generate sealing. The, in particular ceramics, heating unit 36j comprises a heating conductor 70j which, in a heating region of the, in particular ceramics, heating unit 36j, is surrounded at least substantially completely by a heat-conducting, in particular ceramics, base body 40j of the, in particular ceramics, heating unit 36j.

The sealing device 10j has at least one test unit 16j, integrated at least partly in the sealing unit 14j, for monitoring a sealing quality of the container sealed by the sealing unit 14j. The test unit 16j comprises at least one temperature sensor 18j, in particular a plurality of temperature sensors 18j, for detecting a sealing temperature. The temperature sensor 18j is arranged in a sensor material recess of the sealing tool 34j of the sealing unit 14j, wherein the sensor material recess of the sealing tool 34j is arranged in a proximity of the, in particular ceramics, heating unit 36j. Preferably, the sensor material recess is arranged outside the, in particular ceramics, base body 40j of the, in particular ceramics, heating unit 36j. The sensor material recess is preferably arranged directly in the sealing tool 34j. Preferably, the sensor material recess is arranged laterally offset with respect to the, in particular ceramics, heating unit 36j, preferably laterally offset with respect to the, in particular ceramics, base body 40j. Preferably, the sensor material recess, when seen in a direction running at least substantially perpendicular to a sealing direction 44j of the sealing device 10j, is arranged within a region delimited by the, in particular ceramics, base body 40j. Preferably, the sensor material recess, when seen in a direction running at least substantially perpendicular to the sealing direction 44j of the sealing device 10j, is at a maximum distance in particular of less than 25 mm, preferably of less than 10 mm and particularly preferably of less than 8 mm, from an outer surface, facing the sensor material recess, in particular the temperature sensor 18j arranged therein, of the, in particular ceramics, base body 40j.

The temperature sensor 18j, in a state arranged in the sensor material recess, when viewed in a direction running at least substantially perpendicular to a sealing direction 44j of the sealing device 10j, is arranged within the region delimited by the, in particular ceramics, base body 40j. Preferably, the temperature sensor 18j is arranged in the sensor material recess of the sealing tool 34j in such a manner that the temperature sensor 18j, in particular a temperature detection region of the temperature sensor 18j, such as, for example, a temperature sensor tip or the like, is arranged spaced apart from a sealing surface, in particular a sealing outer surface, of the sealing tool or a contact plane of the sealing unit 14j by a, in particular maximum, distance of in particular less than 10 mm, preferably of less than 5 mm and particularly preferably of less than 2 mm.

The test unit 16j preferably has at least one proofing unit 38j at least for proofing an accommodating space of the sealing unit 14j, in which at least the temperature sensor 18j is arranged. The accommodating space of the sealing unit 14j is preferably delimited by a sealing holder 58j of the sealing unit 14j and the sealing tool 34j. Preferably at least the, in particular ceramics, base body 40j and the temperature sensor 18j are arranged in the accommodating space. Preferably, the proofing unit 38j comprises at least one, in particular ceramics, feedthrough element 108j for the feedthrough of electrical lines, in particular of the heating unit 36j or of the temperature sensor 18j. The proofing unit 38j comprises at least one cable guide element 110j, such as, for example, a cable sleeve or the like, which is in particular arranged on the feedthrough element 108j and is to guide a line, arranged in the feedthrough element 108j, of the heating unit 36j and/or of the temperature sensor 18j out of the feedthrough element 108j, wherein the cable guide element 110j preferably has a proofing or strain-relief function. The proofing unit preferably comprises at least one proofing element 112j, which is arranged at an interface between the sealing holder 58j and the sealing tool 34j, in particular for sealing the accommodating space delimited by the sealing holder 58j and the sealing tool 34j. Preferably, the proofing unit 38j comprises a plurality of proofing elements 112j which are arranged at the interface between the sealing holder 58j and the sealing tool 34j. With regard to further features of the sealing device 10j, reference may be made to FIGS. 1 to 15 and the description thereof.

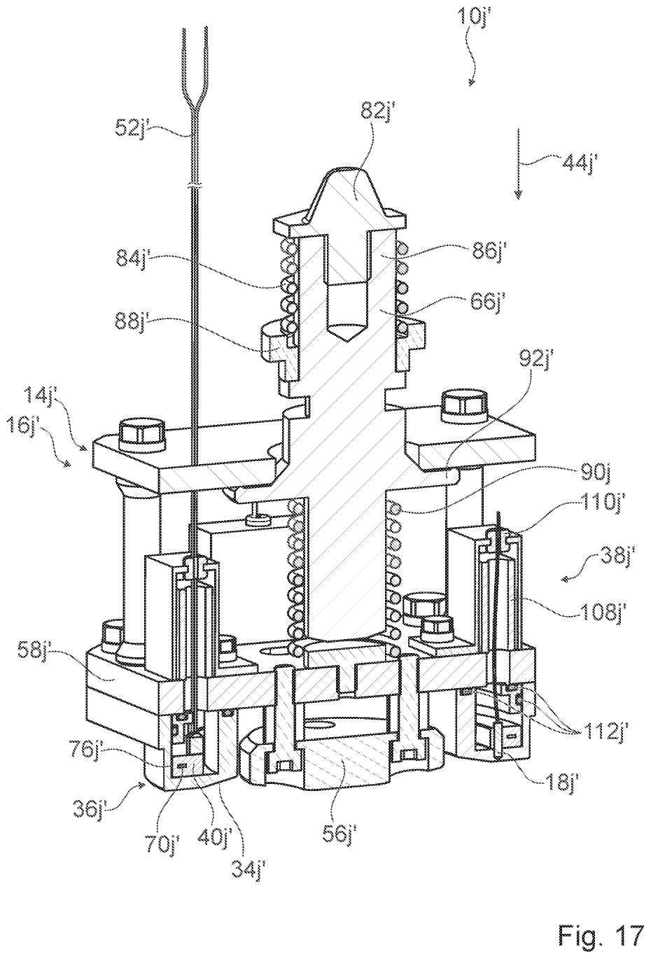

FIG. 17 shows an alternative arrangement of the sensor material recess of the sealing device 10j of FIG. 16, and for this reason the reference signs in FIG. 17 are provided with an apostrophe. In principle, the sealing device 10j′ has an implementation analogous to that of the sealing device 10j of FIG. 16, wherein one difference consists in particular in the arrangement of the sensor material recess of the sealing tool 34j′. The sensor material recess of the sealing tool 34j′, when viewed in the sealing direction 44j′, is arranged beneath the, in particular ceramics, base body 40j′. Preferably, the, in particular ceramics, base body 40j′ comprises a sensor material recess in which the temperature sensor 18j′ is arranged. The sensor material recess of the, in particular ceramics, base body 40j′ is preferably arranged in alignment with the sensor material recess of the sealing tool 34j′, in particular in the sealing direction 44j′. Preferably, the temperature sensor 18j′ is arranged in the sensor material recess of the sealing tool 34j′ and in the sensor material recess of the, in particular ceramics, base body 40j′. The temperature sensor 18j′ is arranged in part in the, in particular ceramics, base body 40j′ and in part in the sealing tool 34j′. The temperature sensor 18j′ preferably extends through the entire, in particular ceramics, base body 40j′ into the sealing tool 34j′. With regard to further features of the sealing device 10j′, reference may be made to FIGS. 1 to 16 and the description thereof.

1. A sealing device for sealing a container (12a; 12e), the sealing device having at least one sealing unit (14a; 14b; 14c; 14d; 14e; 14f; 14g; 14h; 14i; 14j) for a force and/or energy transmission, generating a sealing, to the container (12a; 12e), and having at least one test unit (16a; 16b; 16c; 16d; 16e; 16f; 16g; 16h; 16i; 16j), integrated at least partly in the sealing unit (14a; 14b; 14c; 14d; 14e; 14f; 14g; 14h; 14i; 14j), for monitoring a sealing quality of the container (12a; 12e) sealed by the sealing unit (14a; 14b; 14c; 14d; 14e; 14f; 14g; 14h; 14i; 14j), wherein the test unit (16a; 16b; 16c; 16d; 16e; 16f; 16g; 16h; 16i; 16j) comprises at least one temperature sensor (18a; 18b; 18c; 18d; 18e; 18f; 18g; 18h; 18i; 18j) for detecting a sealing temperature, wherein the temperature sensor (18a; 18b; 18c; 18d; 18e; 18f; 18g; 18h; 18i) is arranged in a sensor material recess of a base body (40a, 42a; 40b, 42b; 40c, 42c; 40d, 42d; 40e; 40f; 40g, 42g; 40h; 40i) of a heating unit (36a; 36b; 36c; 36d; 36e; 36f; 36g; 36h; 36i) of the sealing unit (14a; 14b; 14c; 14d; 14e; 14f; 14g; 14h; 14i), and/or wherein the temperature sensor (18j) is arranged in a sensor material recess of a sealing tool (34j) of the sealing unit (14j), wherein the sensor material recess of the sealing tool (34j) is arranged in a proximity of the heating unit (36j).

2. The sealing device as claimed in claim 1, wherein the test unit (16a; 16b; 16c; 16d; 16e; 16f; 16g; 16i; 16j) comprises at least two temperature sensors (18a, 20a; 18b, 20b; 18c, 20c; 18d, 20d; 18e, 20e; 18f, 20f; 18g, 20g; 18i, 20i; 18j, 20j) for a spatially resolved detection of a sealing temperature.

3. The sealing device as claimed in claim 1, wherein the test unit (16a; 16b; 16c; 16d; 16e; 16f; 16g; 16h; 16i; 16j) comprises at least one applied-pressure sensor (22a; 22e) for detecting a sealing force and/or a sealing pressure.

4. The sealing device as claimed in claim 3, wherein the test unit (16a; 16b; 16c; 16d; 16e; 16f; 16g; 16h; 16i) comprises a pneumatic cylinder (24a; 24e) in or on which the applied-pressure sensor (22a; 22e) is arranged.

5. The sealing device according to claim 1, wherein the test unit (16a; 16b; 16c; 16d; 16e; 16f; 16g; 16i; 16j) comprises at least two temperature sensors (18a, 20a; 18b, 20b; 18c, 20c; 18d, 20d; 18e, 20e; 18f, 20f; 18g, 20g; 18i, 20i; 18j, 20j) and a computing unit for evaluating a test parameter detected by the temperature sensors (18a, 20a; 18b, 20b; 18c, 20c; 18d, 20d; 18e, 20e; 18f, 20f; 18g, 20g; 18i, 20i; 18j, 20j), wherein the computing unit is configured to determine the sealing quality in dependence on a comparison of two values of the test parameter which are detected in at least two different measurement points associated with the same container (12a; 12e).

6. The sealing device according to claim 1, wherein the test unit (16a; 16b; 16c; 16d; 16e; 16f; 16g; 16i; 16j) comprises a computing unit for evaluating a test parameter detected by the temperature sensor (18a, 20a; 18b, 20b; 18c, 20c; 18d, 20d; 18e, 20e; 18f, 20f; 18g, 20g; 18i, 20i; 18j, 20j), wherein the computing unit is configured to evaluate a temporal progression of the test parameter in order to determine the sealing quality.

7. The sealing device according to claim 1, wherein the test unit (16j) has at least one proofing unit (38j) at least for sealing an accommodating space of the sealing unit (14j) in which the at least one temperature sensor (18j) is arranged.

8. A sealing station having at least one sealing carrier (28a) for a support of at least one sealing device, the sealing station having at least one sealing device as claimed in claim 1, and having at least one sealing support (30a) for supporting a container (12a) during sealing.

9. A method for operating a sealing device as claimed in claim 1, wherein, while sealing is being carried out by the sealing unit (14a; 14b; 14c; 14d; 14e; 14f; 14g; 14h; 14i; 14j), the test unit (16a; 16b; 16c; 16d; 16e; 16f; 16g; 16h; 16i; 16j) captures at least one test parameter in order to determine the sealing quality of a container (12a; 12e).

10. The method as claimed in claim 9, wherein in at least one method step the sealing quality of the container (12a; 12e) is determined in dependence on a value of the test parameter of a further container.

11. The method as claimed in claim 9, wherein in at least one method step the sealing quality is determined in dependence on a comparison of two values of the test parameter which are detected in at least two different measurement points associated with the same container (12a; 12e).

12. The method as claimed in claim 9, wherein in at least one method step a temporal progression of the test parameter is evaluated in order to determine the sealing quality.

13. A sealing device for sealing a container (12a; 12e), the sealing device having at least one sealing unit (14a; 14b; 14c; 14d; 14e; 14f; 14g; 14h; 14i; 14j) for a force and/or energy transmission, generating a sealing, to the container (12a; 12e), and having at least one test unit (16a; 16b; 16c; 16d; 16e; 16f; 16g; 16h; 16i; 16j), integrated at least partly in the sealing unit (14a; 14b; 14c; 14d; 14e; 14f; 14g; 14h; 14i; 14j), for monitoring a sealing quality of the container (12a; 12e) sealed by the sealing unit (14a; 14b; 14c; 14d; 14e; 14f; 14g; 14h; 14i; 14j), wherein the test unit (16a; 16b; 16c; 16d; 16e; 16f; 16g; 16h; 16i; 16j) comprises at least one temperature sensor (18a; 18b; 18c; 18d; 18e; 18f; 18g; 18h; 18i; 18j) for detecting a sealing temperature, wherein the test unit (16a; 16b; 16c; 16d; 16e; 16f; 16g; 16i; 16j) comprises at least two temperature sensors (18a, 20a; 18b, 20b; 18c, 20c; 18d, 20d; 18e, 20e; 18f, 20f; 18g, 20g; 18i, 20i; 18j, 20j) and a computing unit for evaluating a test parameter detected by the temperature sensors (18a, 20a; 18b, 20b; 18c, 20c; 18d, 20d; 18e, 20e; 18f, 20f; 18g, 20g; 18i, 20i; 18j, 20j), wherein the computing unit is configured to determine the sealing quality in dependence on a comparison of two values of the test parameter which are detected in at least two different measurement points associated with the same container (12a; 12e).

14. A sealing device for sealing a container (12a; 12e), the sealing device having at least one sealing unit (14a; 14b; 14c; 14d; 14e; 14f; 14g; 14h; 14i; 14j) for a force and/or energy transmission, generating a sealing, to the container (12a; 12e), and having at least one test unit (16a; 16b; 16c; 16d; 16e; 16f; 16g; 16h; 16i; 16j), integrated at least partly in the sealing unit (14a; 14b; 14c; 14d; 14e; 14f; 14g; 14h; 14i; 14j), for monitoring a sealing quality of the container (12a; 12e) sealed by the sealing unit (14a; 14b; 14c; 14d; 14e; 14f; 14g; 14h; 14i; 14j), wherein the test unit (16a; 16b; 16c; 16d; 16e; 16f; 16g; 16h; 16i; 16j) comprises at least one temperature sensor (18a; 18b; 18c; 18d; 18e; 18f; 18g; 18h; 18i; 18j) for detecting a sealing temperature, wherein the test unit (16a; 16b; 16c; 16d; 16e; 16f; 16g; 16i; 16j) comprises a computing unit for evaluating a test parameter detected by the temperature sensor (18a, 20a; 18b, 20b; 18c, 20c; 18d, 20d; 18e, 20e; 18f, 20f; 18g, 20g; 18i, 20i; 18j, 20j), wherein the computing unit is configured to evaluate a temporal progression of the test parameter in order to determine the sealing quality.

15. A sealing device for sealing a container (12a; 12e), the sealing device having at least one sealing unit (14a; 14b; 14c; 14d; 14e; 14f; 14g; 14h; 14i; 14j) for a force and/or energy transmission, generating a sealing, to the container (12a; 12e), and having at least one test unit (16a; 16b; 16c; 16d; 16e; 16f; 16g; 16h; 16i; 16j), integrated at least partly in the sealing unit (14a; 14b; 14c; 14d; 14e; 14f; 14g; 14h; 14i; 14j), for monitoring a sealing quality of the container (12a; 12e) sealed by the sealing unit (14a; 14b; 14c; 14d; 14e; 14f; 14g; 14h; 14i; 14j), wherein the test unit (16a; 16b; 16c; 16d; 16e; 16f; 16g; 16h; 16i; 16j) comprises at least one temperature sensor (18a; 18b; 18c; 18d; 18e; 18f; 18g; 18h; 18i; 18j) for detecting a sealing temperature, wherein the test unit (16j) has at least one proofing unit (38j) at least for sealing an accommodating space of the sealing unit (14j) in which the at least one temperature sensor (18j) is arranged.

16. The sealing device as claimed in claim 2, wherein the test unit (16a; 16b; 16c; 16d; 16e; 16f; 16g; 16h; 16i; 16j) comprises at least one applied-pressure sensor (22a; 22e) for detecting a sealing force and/or a sealing pressure.

17. The method as claimed in claim 10, wherein in at least one method step the sealing quality is determined in dependence on a comparison of two values of the test parameter which are detected in at least two different measurement points associated with the same container (12a; 12e).
